(19) United States
(12) Patent Application Publication
(10) Pub. No.: US 2025/0289831 A1
(43) Pub. Date: Sep. 18, 2025

(54) HIGH PURITY LIGAND-AL-HYDRIDE COMPOSITIONS

(71) Applicant: IMPACT NANO LLC, Lincoln, MA (US)

(72) Inventors: Dirk SCHWEITZER, Lincoln, MA (US); Matthew Damien STEPHENS, Lincoln, MA (US)

(21) Appl. No.: 18/859,864

(22) PCT Filed: Apr. 27, 2023
(86) PCT No.: PCT/US2023/066310

§ 371 Date: Oct. 24, 2024

Related U.S. Application Data
(60) Provisional application No. 63/335,702, filed on Apr. 27, 2022.

(51) Int. Cl. C07F 5/06; B01D 3/02

(52) U.S. Cl. CPC C07F 5/069; B01D 3/02

(57) ABSTRACT

The present disclosure relates generally to compositions comprising ligand-AI-hydride complexes, and methods to make said and related compositions. In particular, the present disclosure provides for a composition comprising a ligand-AI-hydride, wherein the composition has a purity greater than 99%.

### BACKGROUND OF THE DISCLOSURE

### Field

The present disclosure relates to compositions comprising ligand-Al-hydride complexes, especially compositions of high purity, and methods to make said and related compositions.

### Technical Background

Metal hydrides of Group 13 elements are utilized in many practical applications, including synthesis, catalysis, hydrogen storage, and deposition of coatings by methods such as atomic layer deposition. Reported syntheses of aluminum hydrides and aluminyl precursors most frequently utilize diethyl ether as a chelating solvent or additive, in a multiple step synthesis procedure.

However, oxygenated species such as ethers, ketones, or glymes are Lewis base donors, and as such, have the ability to chelate metal and metalloid atoms, in some instances forming Lewis acid-base adducts that are stable compounds.

In atomic layer deposition applications, the Lewis base properties of ethers, ketones, or glymes can be utilized advantageously to prevent deposition for area selective deposition, (Singh et al. 2017) or to stabilize complexes for chemical vapor deposition. (Tang and Zhao 2014). However, since diethyl ether is a Lewis base containing an oxygen, it can be difficult to remove from organometallic substances and therefore can be present in sufficient concentrations to become a deleterious impurity in certain applications. For example, when present as uncontrolled impurities in atomic layer deposition precursors, Lewis bases can poison surface sites, leading to inconsistent film deposition. Further, since precursors are often delivered as gasses, the impurities or their complexes can concentrate over time in the source container, leading to variation in process performance and film characteristics. (Elers et al. 2006) In addition to impacting the thin film deposition process, even very low levels of oxygen contamination can be deleterious to the properties of the deposited films, including electrical properties, in part because the impurities often segregate and concentrate in interfacial regions. (Kim et al. 2020)

Reported syntheses of aluminum hydrides, such as the structures shown in [0009], (Blakeney et al. 2018; Blakeney and Charles H. Winter. 2018), and aluminyl precursors (Hicks et al. 2021) most frequently utilize diethyl ether as a chelating solvent or additive, in a multiple step synthesis procedure. Since diethyl ether is a Lewis base containing an oxygen, it can be difficult to remove from organometallic substances and therefore can be present in sufficient concentrations to become a deleterious impurity in certain applications.

Aside from quality and fitness for use considerations, diethyl ether is a highly volatile flammable solvent and represents a safety risk in industrial manufacturing and it is preferable to avoid its use. Alternative routes presented in the literature involve two step synthesis with isolation of an intermediate compound. These typically utilize pentane as a solvent, which is similarly highly volatile and flammable.

Accordingly, there exists a need to provide compositions and methods which are free from impurities, including oxygen-containing contaminants.

### SUMMARY

The inventors have developed ligated aluminum hydride compositions of surprisingly high purity and processes to make said compositions. The compositions as described herein may further be advantageously low in oxygen-containing molecules (e.g., ethers, such as diethyl ether or glymes), and, in certain embodiments, may also possess exceptional monomeric purity. The enhanced quality of these compositions allows for facile use in atomic layer deposition processes which possess low tolerances for unwanted contaminants.

Accordingly, in one aspect, the present disclosure provides for a composition comprising a compound having the structural formula (I):

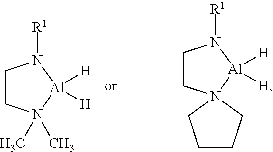

wherein R¹ is a unsubstituted butyl group, and wherein the composition has a purity greater than 99%.

Accordingly, in another aspect, the present disclosure provides for a composition comprising a compound having the structural formula (I):

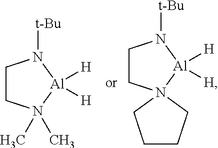

wherein
the composition has a purity greater than 99%.

In certain embodiments as otherwise described herein, the compound is N-(t-butyl) (N′,N′-dimethyl) ethanediamine dihydridoalane. In other embodiments, the compound is N-(t-butyl) (N′,N′-pyrrolidino) ethanediamine dihydridoalane.

In certain embodiments as otherwise described herein, the composition comprises no more than 1000 ppm of an oxygen-containing species.

In another aspect, the present disclosure provides for a method of making a compound having the structural formula (II)

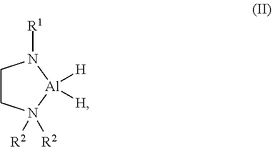

(e.g., in a composition as otherwise described herein), wherein R¹ is a C₁-C₃₃ hydrocarbon, and each R² are independently C₁-C₇ hydrocarbon, or both R² come together to form a substituted or unsubstituted pyrrolidinyl ring; the method comprising:
providing a first solution comprising aluminum trichloride, a chelating agent, and a solvent, wherein the solvent is an aromatic solvent or a chelating solvent;
to the first solution, adding a diamine ligand of formula HN(R¹)CH₂CH₂N(R²)₂ to form a second solution; and
to the second solution, adding a hydride-containing reducing agent to form the composition.

In another aspect, the present disclosure provides for a method of increasing the monomer proportion of a composition, the method comprising:
providing a distillation apparatus comprising a distillation flask connected to a vacuum-jacketed ascending arm, the vacuum-jacketed ascending arm being connected to a fluid-jacketed descending arm at a joint, wherein the joint is enclosed by the fluid-jacket, and the fluid-jacketed descending arm being connected to a receiving flask;
charging the distillation flask with a first composition comprising a compound of structural formula (I):

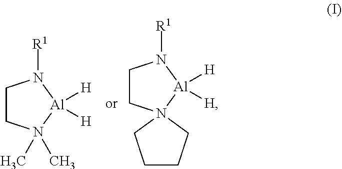

wherein R¹ is a unsubstituted butyl group, wherein the compound is present as a dimer, and optionally also present as a monomer;
reducing the pressure of the distillation apparatus to a pressure in the range of 0.1 Torr to 100 Torr, heating the fluid-jacketed descending arm to a temperature of at least the melting point of a second composition, and heating the distillation flask, whereby the second composition is distilled from the first composition and comprises an increased ratio of monomers to dimers compared to the first composition; and
collecting the second composition in the receiving flask.

Other aspects of the disclosure will be apparent to those skilled in the art in view of the description that follows.

### BRIEF DESCRIPTION OF THE DRAWINGS

FIG. 1: Custom distillation head allowing the distillation at the laboratory scale of compounds under high vacuum whose melting point is above ambient temperature. Purified compound 1 is shown in the photo.

FIG. 2 displays a ¹H NMR of the composition according to Example 4.

FIG. 3 displays a ¹³C NMR of the composition according to Example 4.

FIG. 4 displays an ²⁷Al NMR of the composition according to Example 4.

FIG. 5 displays a ¹H NMR of the composition according to Example 5.

FIG. 6 displays a ¹³C NMR of the composition according to Example 5.

FIG. 7 displays an ²⁷Al NMR of the composition according to Example 5.

### DETAILED DESCRIPTION

The present inventors have developed compositions comprising ligated alane hydride complexes of high purity. Metal hydrides of Group 13 elements are utilized in many practical applications, including synthesis, catalysis, hydrogen storage, and deposition of coatings by methods such as atomic layer deposition. The disclosed compositions are of enhanced utility for applications with strict tolerances for impurities, especially oxygen-containing impurities, such as atomic layer deposition.

Accordingly, in one aspect, the present disclosure provides for a composition comprising a compound having the structural formula (I):

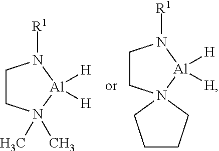

wherein R¹ is a unsubstituted butyl group, and wherein the composition has a purity greater than 99%.

In certain embodiments as otherwise described herein, R¹ is t-butyl or sec-butyl.

In another aspect, the present disclosure provides for a composition comprising a compound having the structural formula (I):

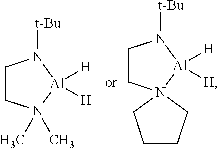

wherein
the composition has a purity greater than 99%.

In particular embodiments as otherwise described herein, the compound is N-(t-butyl) (N′,N′-dimethyl) ethanediamine dihydridoalane. In other embodiments, the compound is N-(t-butyl) (N′,N′-pyrrolidino) ethanediamine dihydridoalane.

Advantageously, the present inventors have developed a composition that possesses very low amounts of oxygen-containing species. This is advantageous, as trace oxygen has been found to bind to aluminum and create defects during atomic layer deposition, including oxygen incorporated into the film. Accordingly, in certain embodiments as otherwise described herein, the composition comprises no more than 1000 ppm of an oxygen-containing species. For example, in particular embodiments, the composition comprises no more than 500 ppm, no more than 250 ppm, no more than 100 ppm, no more than 50 ppm, or no more than 10 ppm of an oxygen-containing species. As used herein, the oxygen-containing species proportion is by weight of the molecule containing the oxygen atom.

Numerous chemical species may contain oxygen. In certain embodiments as otherwise described herein, the oxygen-containing species may comprise an ether, carbonyl, alcohol, carbonate, or carboxylic acid residue, or a salt thereof. In various embodiments, the oxygen-containing species comprises an ether moiety, e.g., as part of an ether or a glyme, such as diethyl ether, di-n-propyl ether, t-butyl methyl ether, tetrahydrofuran, monoglyme, diglyme, triglyme, or tetraglyme. For example, in particular embodiments, the oxygen-containing species comprises diethyl ether, monoglyme, diglyme, triglyme, or tetraglyme.

The disclosed compositions are found to have to possess enhanced properties relative to conventional dihydridoalane compositions. In particular, conventional compositions tend to crystallize and/or solidify upon cooling to near-ambient temperatures. This tendency hinders facile transportation and usage, such as the ability to transfer the composition between containers through pouring or pumping the liquid. Further, a liquid composition advantageously allows facile handling and more consistent volumetric measurements compared to a solid. Without wishing to be bound by theory, it has been presently found that this solidification is instigated by the presence of impurities, even in only small amounts. Potential impurities include trace salts, and/or oxygen-containing species. Thus, the production of a highly pure composition, such as accordingly to the present disclosure, may result in the ability to cool the composition without accompanying solidification via a phenomenon known as undercooling or supercooling. Accordingly, in certain embodiments as otherwise described herein, the composition is a liquid composition. In particular embodiments, the composition is an undercooled liquid composition at ambient pressure and ambient pressure (e.g., 1 atm and 25° C.). For example, in particular embodiments, the compound of the composition is N-(t-butyl) (N′,N′-pyrrolidino) ethanediamine dihydridoalane, and the composition is a liquid composition at ambient pressure and temperature. In certain embodiments as otherwise described here, the compound of the composition is N-(sec-butyl) (N′,N′-pyrrolidino) ethanediamine dihydridoalane, and the composition is a liquid composition at ambient pressure and temperature.

Advantageously, the liquid composition as otherwise described herein has low solids content. Accordingly, in certain embodiments as otherwise described herein, the composition comprises less than 5 wt % solids at a temperature of no more than 25° C. (e.g., at a temperature of 25° C.). In particular embodiments the composition comprises less than 2 wt % solids, or 1 wt % solids, or 0.5 wt % solids at a temperature of 25° C. For example, in various embodiments, the composition is at ambient pressure. Solids content may be determined through any technique known in the art, including heating the composition to a temperature sufficient to obtain a pure liquid phase, then cooling to the target temperature followed by solids separation, e.g., filtration.

Additionally, it is known that the dihydridoalane complexes in conventional compositions have a tendency to dimerize, or form multimeric species. However, the present inventors have surprisingly determined that certain compositions according to the present disclosure resist dimerization, and rather maintain their monomeric form. Accordingly, in certain embodiments as otherwise described herein, the compound is N-(t-butyl) (N′,N′-pyrrolidino) ethanediamine dihydridoalane, and is present in at least 99 mol % monomeric form. For example, in particular embodiments, the compound is present in at least 99.9% monomeric form. In other embodiments, the compound is N-(sec-butyl) (N′,N′-pyrrolidino) ethanediamine dihydridoalane or N-(sec-butyl) (N′,N′-dimethyl) ethanediamine dihydridoalane, and is present in at least 99% monomeric form (e.g., at least 99.9% monomeric form). The relative proportions of monomeric, dimeric, and multimeric species may be measured by NMR spectroscopy, in particular ¹H, ¹³C, and ²⁷Al NMR spectroscopy.

In another aspect, the present disclosure provides for a method of making a compound having the structural formula (II)

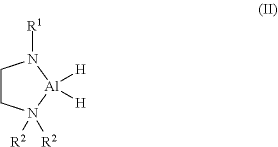

(e.g., in a composition as otherwise described herein), wherein R¹ is a C₁-C₃₃ hydrocarbon, and each R² are independently C₁-C₇ hydrocarbon, or both R² come together to form a substituted or unsubstituted pyrrolidinyl ring, the method comprising:
providing a first solution comprising aluminum trichloride, a chelating agent, and a solvent, wherein the solvent is an aromatic solvent or a chelating solvent;
to the first solution, adding a diamine ligand of formula HN(R¹)CH₂CH₂N(R²)₂ to form a second solution;
to the second solution, adding a hydride-containing reducing agent to form the composition.

Terms used herein may be preceded and/or followed by a single dash, “—”, or a double dash, “═”, to indicate the bond order of the bond between the named substituent and its parent moiety; a single dash indicates a single bond and a double dash indicates a double bond or a pair of single bonds in the case of a spiro-substituent. In the absence of a single or double dash it is understood that a single bond is formed between the substituent and its parent moiety; further, substituents are intended to be read “left to right” with reference to the chemical structure referred to unless a dash indicates otherwise. For example, arylalkyl, arylalkyl-, and -alkylaryl indicate the same functionality.

For simplicity, chemical moieties are defined and referred to throughout primarily as univalent chemical moieties (e.g., alkyl, aryl, etc.). Nevertheless, such terms are also used to convey corresponding multivalent moieties under the appropriate structural circumstances clear to those skilled in the art. For example, while an “alkyl” moiety can refer to a monovalent radical (e.g., CH₃—CH₂—), in some circumstances a bivalent linking moiety can be “alkyl,” in which case those skilled in the art will understand the alkyl to be a divalent radical (e.g., —CH₂—CH₂—), which is equivalent to the term “alkylene.” (Similarly, in circumstances in which a divalent moiety is required and is stated as being “aryl,” those skilled in the art will understand that the term “aryl” refers to the corresponding divalent moiety, arylene). All atoms are understood to have their normal number of valences for bond formation (i.e., 4 for carbon, 3 for N, 2 for 0, and 2, 4, or 6 for S, depending on the oxidation state of the S). Nitrogens in the presently disclosed compounds can be hypervalent, e.g., an N-oxide or tetrasubstituted ammonium salt. On occasion a moiety may be defined, for example, as —B-(A)ₐ, wherein a is 0 or 1. In such instances, when a is 0 the moiety is —B and when a is 1 the moiety is —B-A.

As used herein, hydrocarbon refers to alkyl, alkenyl, alkynyl, cycloalkyl, and aryl groups. As used herein, the term “alkyl” includes a saturated hydrocarbon having a designed number of carbon atoms, such as 1 to 10 carbons (i.e., inclusive of 1 and 10), 1 to 8 carbons, 1 to 6 carbons, 1 to 3 carbons, or 1, 2, 3, 4, 5 or 6. Alkyl group may be straight or branched and depending on context, may be a monovalent radical or a divalent radical (i.e., an alkylene group). For example, the moiety “—(C₁-C₆ alkyl)-O—” signifies connection of an oxygen through an alkylene bridge having from 1 to 6 carbons and C₁-C₃ alkyl represents methyl, ethyl, and propyl moieties. Examples of “alkyl” include, for example, methyl, ethyl, propyl, isopropyl, butyl, iso-, sec- and tert-butyl, pentyl, and hexyl.

The term “alkoxy” represents an alkyl group of indicated number of carbon atoms attached to the parent molecular moiety through an oxygen bridge. Examples of “alkoxy” include, for example, methoxy, ethoxy, propoxy, and isopropoxy.

The term “cycloalkyl” refers to a non-aromatic carbocyclic ring or ring system, which may be saturated (i.e., a cycloalkyl) or partially unsaturated (i.e., a cycloalkenyl). The cycloalkyl ring optionally fused to or otherwise attached (e.g., bridged systems) to other cycloalkyl rings. Certain examples of cycloalkyl groups present in the disclosed compounds have from 3 to 7 members in a single ring, such as having 5 or 6 members in a single ring. In some embodiments, the cycloalkyl groups have 3, 4, 5, 6 or 7 members in a single ring. Examples of cycloalkyl groups include, for example, cyclohexyl, cyclopentyl, cyclobutyl, cyclopropyl, tetrahydronaphthyl and bicyclo[2.2.1]heptane. The cycloalkyl groups herein are unsubstituted or, when specified as “optionally substituted”, may be substituted in one or more substitutable positions with various groups, as indicated.

The term “substituted,” when used to modify a specified group or radical, means that one or more hydrogen atoms of the specified group or radical are each, independently of one another, replaced with the same or different substituent groups as defined below, unless specified otherwise.

The term “aryl” represents an aromatic ring system having a single ring (e.g., phenyl) which is optionally fused to other aromatic hydrocarbon rings or non-aromatic hydrocarbon or heterocycle rings. “Aryl” includes ring systems having multiple condensed rings and in which at least one is carbocyclic and aromatic, (e.g., 1,2,3,4-tetrahydronaphthyl, naphthyl). Examples of aryl groups include phenyl, 1-naphthyl, 2-naphthyl, indanyl, indenyl, dihydronaphthyl, fluorenyl, tetralinyl, and 6,7,8,9-tetrahydro-5H-benzo[a]cycloheptenyl. “Aryl” also includes ring systems having a first carbocyclic, aromatic ring fused to a nonaromatic heterocycle, for example, 1H-2,3-dihydrobenzofuranyl and tetrahydroisoquinolinyl. “Aryl” also includes polycyclic ring systems formed from a plurality of rings, such as 1, 2, 3, 4, 5, or 6 aryl rings, wherein each ring is fused or joined by a C₁ bridging carbon, such as a —CH₂— or —CH— or —C— group as required. The aryl groups herein are unsubstituted or, when specified as “optionally substituted”, can unless stated otherwise be substituted in one or more substitutable positions with various groups as indicated.

Accordingly, in certain embodiments as otherwise described herein, R¹ is a C₁-C₈ alkyl group, or aryl group, wherein the aryl group comprises 1-5 phenyl rings, wherein the phenyl rings are fused or joined by C₁ bridging carbons, and wherein each phenyl ring is independently and optionally substituted by 1-3 C₁-C₄ alkyl groups. For example, in certain embodiments, R¹ an aryl group, wherein the aryl group is 2,6-di-iso-propylphenyl (Dipp), 2,6-bis(diphenyl-methyl)-p-toly (Dipp*), or 2,6-dimethylphenyl (Dmp). In certain embodiments as otherwise described herein, R¹ is a C₂-C₆ alkyl group, e.g., an unsubstituted C₂-C₆ alkyl group. In particular embodiments, R¹ is unsubstituted butyl, such as t-butyl or sec-butyl. For example, in some embodiments, R¹ is t-butyl.

In various embodiments as otherwise described herein, each R² is independently an unsubstituted C₁-C₄ group. For example, in some embodiments R² is methyl or ethyl, e.g., both R² are methyl. In other embodiments, both R² come together to form a substituted or unsubstituted pyrrolidinyl ring. For example, in certain embodiments, both R² come together to form an unsubstituted pyrrolidinyl ring.

In various embodiments as otherwise described herein, the chelated agent is an amine, such as a tertiary amine. For example, in certain embodiments, the chelating agent is of formula N(R³)₃, wherein each R³ is independently C₁-C₈ alkyl or aryl. For example, in some embodiments, each R³ is independently unsubstituted C₁-C₆ alkyl, or unsubstituted phenyl. In particular embodiments, the chelating agent is triethylamine. It has been surprisingly discovered that primary and secondary amines can yield unwanted byproducts, including, in some cases unwanted polymer products. Accordingly, in various embodiments as otherwise described herein, the chelating agent is not a secondary amine or tertiary amine.

It has been surprisingly found that the use of particular solvents leads to enhanced compound synthesis, for example, in some embodiments, increased composition purity, and/or monomer proportion. Accordingly, in various embodiments as otherwise described herein, the solvent is an aromatic solvent. For example, in certain embodiments, the solvent comprises benzene, toluene, xylene, ethylbenzene, or trimethylbenzene. For example, at least 90 wt % of all solvents present may be an aromatic as otherwise described herein (e.g., at least 95 wt %, or at least 99 wt %). Wherein the solvent is an aromatic solvent, in certain embodiments as otherwise described herein, the solvent comprises no more than 1000 ppm of an oxygen-containing species (e.g., no more than 500 ppm, no more than 250 ppm, no more than 100 ppm, no more than 50 ppm, or no more than 10 ppm of an oxygen-containing species). As used herein, the oxygen-containing species proportion is by weight of the molecule containing the oxygen atom. In various other embodiments as otherwise described herein, the solvent is a chelating solvent. For example, in certain embodiments, the solvent comprises an ether (e.g., comprises diethyl ether, di-n-propyl ether, t-butyl methyl ether, tetrahydrofuran, monoglyme, diglyme, triglyme, or tetraglyme). For example, at least 90 wt % of all solvents present may be an ether as otherwise described herein (e.g., at least 95 wt %, or at least 99 wt %).

In certain embodiments as otherwise described herein, the hydride-containing reducing agent comprises an inorganic hydride, for example, diisobutylaluminum hydride, lithium aluminum hydride, or sodium aluminum hydride. In particular embodiments, the hydride-containing reducing agent comprises lithium aluminum hydride.

A common issue in the preparation of aluminum hydride molecules is their propensity to form dimers. This can be a major challenge, as the larger dimers have poor volatility, and customary solutions, such as the installation of bulky ligands, also can negatively impact volatility and thus ALD performance. It has been surprisingly found that, in certain embodiments, distillation can be used to increase the monomer composition. Accordingly, in certain embodiments as otherwise described herein, the method as otherwise described herein further comprises distilling (e.g., reactive distilling), wherein the distilling increases the monomer proportion of the composition.

In another aspect, the present disclosure provides for a distillation apparatus, the distillation apparatus comprising a distillation flask connected to a vacuum-jacketed ascending arm, which is connected to a fluid-jacketed descending arm at a joint, wherein the joint is enclosed by a fluid-jacket, which is connected to a receiving flask. In certain embodiments, the joint is entirely enclosed by the fluid jacket. It has presently been determined that the fluid jacket enclosing the joint between the ascending arm and descending arm can advantageously prevent clogging caused be premature deposition of distilled compounds.

The fluid of the fluid jacket may be any suitable heat-transfer fluid known in the art. For example, in certain embodiments as otherwise described herein, the fluid comprises water or ethylene glycol, or a synthetic hydrocarbon- or silicone-based fluid. In some embodiments, the fluid comprises a gas.

In another aspect, the present disclosure provides for a method of increasing the monomer proportion of a composition, the method comprising:
providing a distillation apparatus comprising a distillation flask connected to a vacuum-jacketed ascending arm, the vacuum-jacketed ascending arm being connected to a fluid-jacketed descending arm at a joint, wherein the joint is enclosed by the fluid-jacket, and the fluid-jacketed descending arm being connected to a receiving flask;
charging the distillation flask with a first composition comprising a compound as otherwise described herein, for example a compound of structural formula (I):

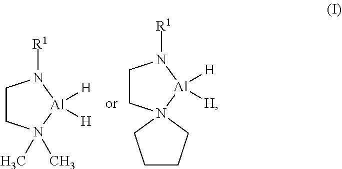

wherein R¹ is a unsubstituted butyl group;
wherein the compound is present as a dimer, and optionally also present as a monomer;
reducing the pressure of the distillation apparatus to a pressure in the range of 0.1 Torr to 100 Torr, heating the fluid-jacketed descending arm to a temperature of at least the melting point of a second composition, and heating the distillation flask, whereby the second composition is distilled from the first composition and comprises an increased ratio of monomers to dimers compared to the first composition; and
collecting the second composition in the receiving flask.

In certain embodiments as otherwise describe herein, the distillation flask is heated to a temperature in order to effect boiling and/or sublimation of the first composition, e.g., to a temperature of at least 5° C. below the boiling point of the first composition, or greater. For example, in some embodiments, the distillation flash is heated to the boiling point of the first composition.

The boiling points, melting points, and/or sublimation points of the compounds and compositions as disclosed herein are variable depending on the chemical composition, purity, monomeric and/or dimeric or polymeric form, and other factors. Furthermore, these temperatures are pressure dependent. Accordingly, a person of ordinary skill in the art would be able to readily ascertain the appropriate boiling points, melting points, and/or sublimation points of a particular compound or composition in question in light of these variables and the present disclosure.

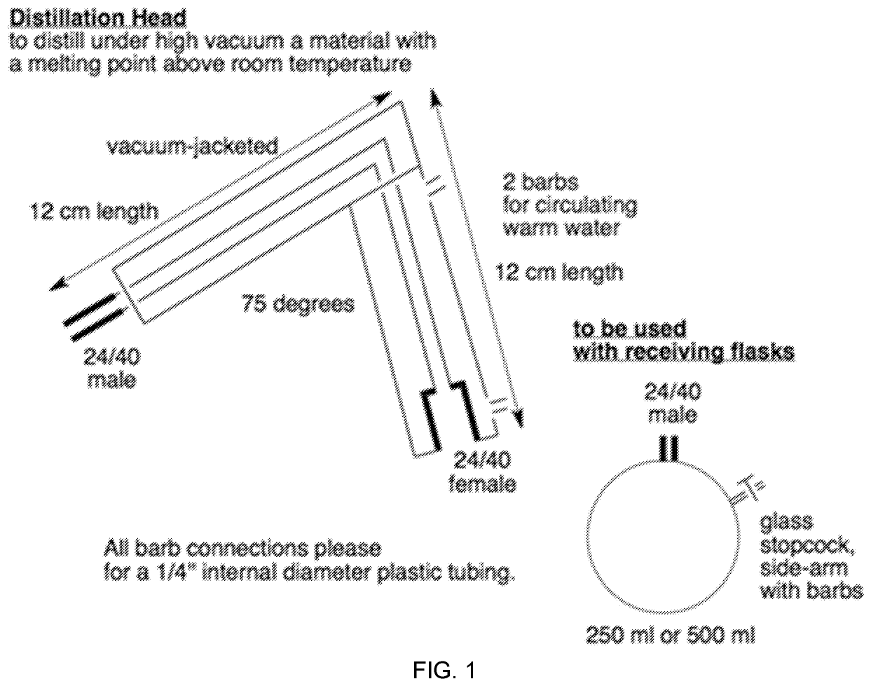

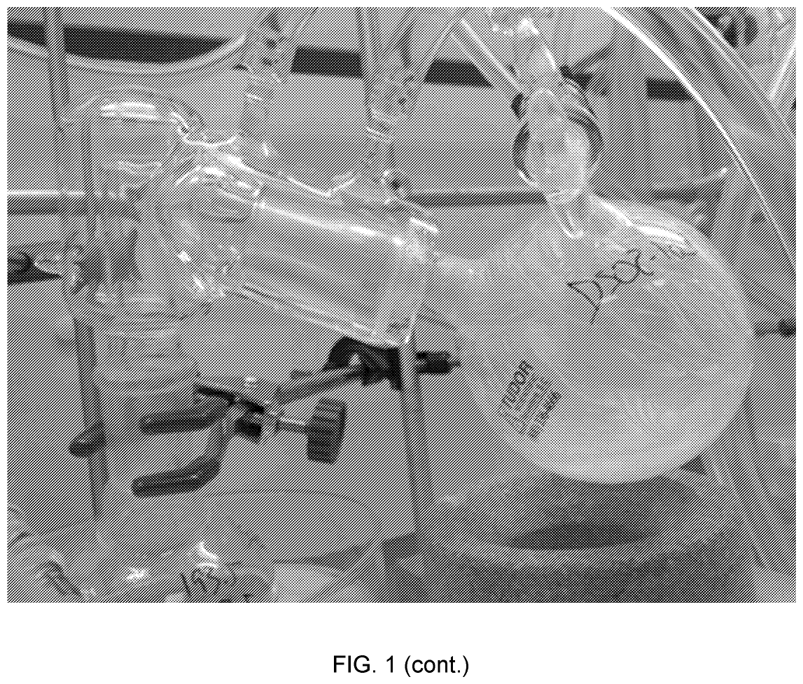

For example, in certain embodiments as otherwise described herein, the distillation apparatus is as known in FIG. 1.

### EXAMPLES

The Examples that follow are illustrative of specific embodiments of the methods of the disclosure, and various uses thereof. They are set forth for explanatory purposes only, and are not to be taken as limiting the scope of the disclosure.

The present disclosure includes a novel, “one-pot” synthesis method that produces the desired product with yields>90% and utilizes solvents that are less volatile than diethyl ether or pentane. In one embodiment, no oxygenated solvent or chelating agent is employed, enabling synthesis of high purity compositions free from oxygenated solvent impurities. In another embodiment, an oxygenated, chelating solvent monoglyme is utilized, but the synthesis method differs significantly from the prior art in that all reagents are combined in one pot, yet the reaction surprisingly produces the desired product in high yield with minimal side reactions under the conditions employed.

CVD/ALD “precursor” chemicals for Aluminum, such as [NMe2EtNtBu]AlH2 (1), (Blakeney and Winter 2018) [PyrNEtNtBu]AlH2 (2), (Blakeney et al. 2018) [NHtBuEtNtBu]AlH2 (3), (Atwood et al. 1994) and [NMe2EtNMe]AlH2 (4), (McMahon et al. 1999) have been synthesized in diethyl ether as the solvent.

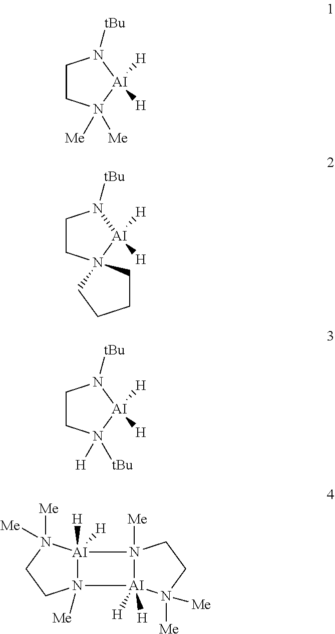

Structures of [NMe2EtNtBu]AlH2 (1), [PyrNEtNtBu]AlH2 (2), [NHtBuEtNtBu]AlH2 (3), and [NMe2EtNMe]AlH2 (4). Compound 4 was isolated as its crystalline dimer.

These syntheses in diethyl ether have been done at a very low concentration, which is a very uneconomical process. Besides diethyl ether being a process hazard due to its high flammability (flash point=−45° C.) even trace quantities of residual diethyl ether could introduce defects at a level too high for current electronic chips.

Herein, we disclose the syntheses of Ligand-Aluminum-Hydride complexes such as 1 and 2, using three different methods. Two of these, processes A and B, do not utilize an Oxygen-containing solvent in the final step of assembling the Ligand-Aluminum-Hydride complex.

### Example 1: Synthesis of N-(t-butyl) (N′,N′-dimethyl) ethanediamine (Ligand for Compound 1)

### Synthesis

In a 350 ml pressure vessel (Kemtech America) containing a magnetic stir bar were combined in the order of 2-chloro-N,N-dimethylethylamine hydrochloride (50.0 g, 0.347 mol), tert-butyl amine (101.6 g, 1.388 mol, 4 eq.), and water (7.1 g, 0.394 mol, 1.1 eq.). The pressure vessel was closed and heated behind a safety shield for 6 h to 75° C. (oil bath temperature). It is a solid to solid reaction.

### Isolation

After cooling to room temperature, an aqueous solution of NaOH (27.8 g, 0.695 mol, 2 eq. in 70 g H2O) and more water (80 g) were added, and the resulting mixture was allowed to sit at room temperature for several hours until all solid has dissolved to form two liquid phases. GC analysis showed that the desired product is present in both liquid phases. The product has a very high water solubility. Repeated manual extractions with hydrocarbons or ethyl acetate using a separation funnel only resulted in a low isolated yield of about 20%. Thus, a continuous extraction using the apparatus of AceGlass (part #6846-50) was performed to extract the product from the aqueous phase to the hexanes phase. Two 50 g reactions and brine (337 g) were added to the extraction vessel. Hexanes (600 g) were added to the sump flask. Using a oil bath temperature of 140° C. the sump flask was now heated for 10 h. Half of the aqueous phase was drained from the extraction vessel, another 50 g reaction and more brine were added, and the extraction was continued for another 10 h. For a second time, half of the aqueous phase was drained from the extraction vessel, another 50 g reaction and more brine were added, and the extraction was continued for another 10 h. In total, four 50 g reactions were used in a single continuous extraction. The hexanes phase was concentrated on a rotavap (135 Torr, 45° C. followed by 100 Torr, 45° C. for 15 min) to provide 132.5 g (0.918 mol, 66% isolated yield) of crude product.

### Purification

Distillation through a column was performed to obtain the NMe2EtNHtBu ligand (b.p. 72° C. at 60 Torr) at a 99.5+ % GC-FID purity. ¹H NMR (400 MHz, C6D6)=2.53 (t, 2H), 2.30 (t, 2H), 2.05 (s, 6H), 1.02 (s, 9H). ¹³C NMR (100 MHz, C6D6)=60.61, 50.01, 45.79, 40.56, 29.71.

### Example 2: Synthesis of N-(t-butyl) (N′,N′-pyrrolidino) ethanediamine (Ligand for Compound 2)

### Synthesis

In a 350 ml pressure vessel (Kemtech America) containing a magnetic stir bar were combined in the order of 1-(2-chloroethyl)pyrrolidine hydrochloride (50.0 g, 0.294 mol), tert-butyl amine (107.5 g, 1.470 mol, 5 eq.), and water (7.9 g, 0.441 mol, 1.5 eq.). The pressure vessel was closed and heated behind a safety shield for 6 h to 75° C. (oil bath temperature). It is a solid to solid reaction.

### Isolation

After cooling to room temperature, an aqueous solution of NaOH (23.5 g, 0.588 mol, 2 eq. in 70 g H2O) and more water (60 g) were added, and the resulting mixture was allowed to sit at room temperature for several hours until all solid has dissolved to form two liquid phases. A continuous extraction using the apparatus of AceGlass (part #6846-50) was performed to extract the product from the aqueous phase to the hexanes phase. Two 50 g reactions and brine (330 g) were added to the extraction vessel. Hexanes (600 g) were added to the sump flask. Using a oil bath temperature of 140° C. the sump flask was now heated for 9 h. Half of the aqueous phase was drained from the extraction vessel, another 50 g reaction and more brine were added, and the extraction was continued for another 9 h. For a second time, half of the aqueous phase was drained from the extraction vessel, another 50 g reaction and more brine were added, and the extraction was continued for another 13 h. In total, four 50 g reactions were used in a single continuous extraction. The hexanes phase was concentrated on a rotavap (135 Torr, 45° C. followed by 100 Torr, 45° C. for 30 min) to provide 210.2 g (1.234 mol, 104% isolated yield, thus, a quantitative reaction and isolation) of crude product.

### Purification

Distillation through a column was performed to obtain the PyrNEtNHtBu ligand (b.p. 76° C. at 8 Torr) at a 99.5+% GC-FID purity. ¹H NMR (400 MHz, C6D6)=2.58 (m, 2H), 2.50 (t, 2H), 2.35 (m, 4H), 1.58 (p, 4H), 1.01 (s, 9H). ¹³C NMR (100 MHz, C6D6)=57.43, 54.58, 50.09, 41.90, 29.78, 24.33.

### Example 3: Synthesis of N-(t-butyl) (N′,N′-dimethyl) ethanediamine dihydridoalane ([NMe2EtNtBu]AlH2, Compound 1)

### Process A

We have shown that Ligand-Aluminum-Hydride complexes can be directly synthesized in a clean reaction from the free ligand and a solution of the preformed commercially available (Aldrich product #400386) [NMe2Et]AlH3 in PhMe, Process A, at room temperature. Presumably, this reaction involves the formation of an intermediate in which both NMe2Et and the ligand, in a monodentate fashion, are coordinated to the Al. Driven by entropy, this intermediate then rearranges into our desired product while liberating NMe2Et. The synthesis of [NMe2Et]AlH3 in pentane as the solvent and its isolation has been reported. (Frigo et al. 1994)

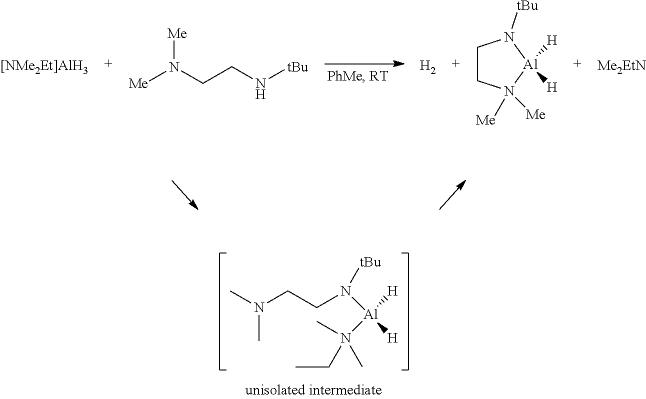

Equation of Process A, with Unisolated Intermediate Shown.

A solution of [NMe2Et]AlH3 in PhMe (Aldrich product #400386, 0.5 M in PhMe, 11.84 g, d=0.8037 g/ml, 7.07 mmol) was added to the neat NMe2EtNHtBu ligand (1.02 g, 7.07 mmol). The resulting mixture was stirred. After 2 h reaction time no more gas bubble formation occurred. An intermediate white precipitate was formed, which after 4 h of reaction time had disappeared. ¹H and ¹³C NMR analysis of the crude reaction mixture showed clean [NMe2EtNtBu]AlH2 product being present.

### Process B

Surprisingly, we have found that Ligand-Aluminium-Hydride complexes can also be synthesized cleanly in a one-pot reaction between the free ligand, NRR′R″, AlCl3, and LiAlH4 in PhMe, Process B. Using n-heptane instead of PhMe as the solvent caused the reaction rate to decrease, so that after 2 weeks still unreacted LiAlH4 was present in the reaction mixture. We have compared NMe2Et and NEt3; the reaction using NEt3 proceeds faster. (Marlett and Park 1990) Conducting the reaction at an elevated temperature of 35 or 45° C. did not result in a faster reaction. This reaction is a complex process. First AlCl3 is dissolved in a mixture of PhMe and NEt3, whereupon the reaction mixture becomes warm. The ligand is now added all at once, whereupon only a slight increase in temperature is observed; however, now an orange colored phase, corresponding to about the volume of the ligand, forms below a near colorless phase. However, the ligand by itself is miscible with PhMe in all ratios. Finally, LiAlH4 in the form of pellets (Aldrich product #323403) is added all at once. Over the course of 7 days, the LiAlH4 pellets react away, while Hydrogen bubbles are formed and the orange color disappears. This process happens while the reaction mixture is in a high viscosity “gel” state, indicative of ligand cross-linked Al ions. At the end of the reaction, an only weakly yellow solution, with a fine white powder (LiCl) suspended in it, is present. Speculating on the structures of the various intermediates of this complex process is outside of the scope of a patent. This Al complex synthesis in NEt3/PhMe takes 7 days to go to completion. In comparison, conducting the reaction in DME takes only 15 h to go to completion.

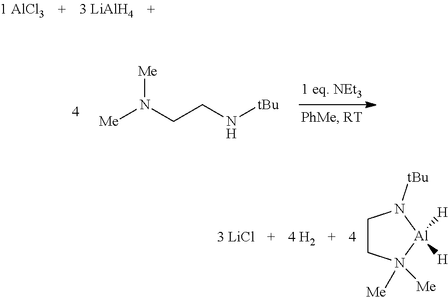

### Equation of Process B.

Process B—[NMe2EtNtBu]AlH2 Complex Synthesis—One Pot from Free Ligand, NEt3, AlCl3 and LiAlH4 in PhMe—Oxygen-Free Solvent Route

The complete synthesis and isolation procedure was performed in a glove box, while the purification distillation was done on a Schlenk line under a fume hood. This NEt3/PhMe procedure has so far been successfully repeated three times at the 150 g scale.

### Synthesis

Into a plastic bottle LiAlH4 (26.20 g, 0.690 mol) pellets (˜0.5 g each) were weighed out, and the bottle was closed until used. NMe2EtNHtBu ligand (126.14 g, 0.874 mol, 0.95 eq., limiting reagent) was weighed out in a flask. AlCl3 (30.68 g, 0.230 mol) was weighed out in a beaker. Using PhMe (102 g) the AlCl3 was transferred via a funnel into a 1 L side-arm flask containing a magnetic stir bar. NEt3 (93.14 g, 0.920 mol) was added to a 250 ml flask containing a magnetic stir bar. PhMe (31 g) was added to the NEt3, and the combined liquid was stirred until a single phase was present. A temperature probe was now installed in the AlCl3 in PhMe suspension. Over the course of 1 h the NEt3/PhMe solution was added pipettewise to the AlCl3/PhMe suspension at a rate so that the internal temperature did not exceed 53° C. A clear, weakly orange solution formed. Once the internal temperature had cooled to 31° C., the temperature probe was replaced by a funnel. All ligand was now poured in, followed by washing of the ligand flask and funnel with PhMe (28 g). The temperature probe was installed again. A two liquid phases system, with an unchanged temperature of 31° C., has formed, consisting of an upper colorless large and a lower orange small phase. The temperature probe was removed and washed with PhMe (3 g). In total, 164 g of PhMe were used in this reaction. A solid addition funnel was now installed, and the LiAlH4 pellets were added in 3 batches in 10 min intervals. The flask was now closed with a rubber septum and kept at room temperature, while keeping the side arm open, so that the produced H2 can escape into the box atmosphere. The glove box atmosphere was occasionally purged so as to remove the H2 from its atmosphere. After 7 days of reaction time, a fine white powder (LiCl) was present in a weakly yellow solution, indicating that the reaction had completed.

### Isolation

All PhMe and NEt3 was now evaporated using a Dewar style vacuum solvent trap condenser placed outside of the glove box under a fume hood, connected via tubing to the inside of the glove box. The 1 L reaction flask was slightly heated in an Al chip bath (Tset=30° C.) to facilitate evaporation. The resulting residue was taken up in n-heptane (125 g) and filtered to remove the LiCl through a 0.5 micron disk, cut out from a sock filter, placed on a 20 micron polyethylene frit in a disposable filter funnel, into a weighed 1 L side-arm containing a magnetic stir bar. The reaction flask and filter cake were washed with n-heptane (67 g). The heptane was now evaporated to obtain a near colorless liquid residue (153.0 g). A sample of it (0.5 g) was removed for NMR analysis.

### Purification

Distillation using our custom distillation head, FIG. 1, which allows the distillation of compounds under high vacuum whose melting point is above ambient temperature, provided 143.3 g (0.832 mol, 95.1% isolated yield) of purified product [NMe2EtNtBu]AlH2 (bp=56° C. at 0.7 Torr). The purified product often forms a supercooled colorless liquid, but may spontaneously crystallize to form a white solid. ¹H NMR (400 MHz, C6D6)=4.18 (bs, 2H), 2.72 (t, 2H), 2.33 (t, 2H), 2.01 (s, 6H), 1.21 (s, 9H). ¹³C NMR (100 MHz, C6D6)=61.68, 51.17, 45.02, 41.68, 30.51. 27Al NMR (104 MHz, C6D6)=137 (bs, monomer, 13.28 integration), 69 (bs, dimer, 1.00 integration). The exact chemical shift values of all but the CH2-NH protons (2.72 ppm) are highly dependent on the monomer/dimer ratio, but not any of the ¹³C chemical shifts. The values reported in the literature (Blakeney and Winter 2018) are those of a highly concentrated, thus mostly dimeric, sample.

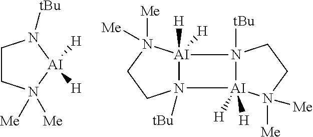

### Structures of Monomeric and Dimeric [NMe2EtNtBu]AlH2.

### Process C

It was also found that Ligand-Aluminum-Hydride complexes can be directly synthesized by the reaction between LiAlH4 and the mono HCl salt of the ligand, Process C. This process has the advantage that the amount of work under an inert atmosphere is minimized. Exposing NMe2EtNHtBu ligand to HCl gas in an alcoholic solvent results in the formation of its bis HCl salt, which is isolated as a white crystalline solid by evaporation of all solvent followed by trituration with n-heptane and drying under high vacuum. Combining the free ligand and a solution of its bis HCl salt in equimolar amounts in methanol, followed by removal of all solvent, enables the isolation of the ligand mono HCl salt as a crystalline solid. [NMe2EtNtBu]AlH2 is formed when NMe2EtNHtBu×1 HCl and LiAlH4 are combined in an equimolar ratio in PhMe/DME and stirred at room temperature. This approach has also been used in the literature to synthesize compound [NMe2EtNMe]AlH2 (4). (Choi 1999)

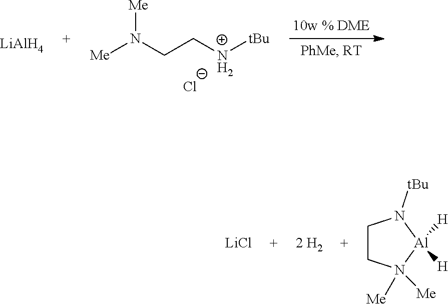

### Equation of Process C.

### NMe2EtNHtBu×2 HCl, Ligand bis HCl Salt, Synthesis

Ligand NMe2EtNHtBu (4.55 g, 0.032 mol) was dissolved in isopropanol (12.6 g). HCl gas, generated from NH4Cl and H2SO4, was bubbled into this solution at room temperature. Within the solution, a white solid started precipitating, looking like snow falling. Throughout the reaction, the gas inlet tube and side of the flask were periodically washed with more isopropanol (21.5 g) into the reaction mixture, since white solid started forming there. All volatiles were removed by rotary evaporation. The resulting residue was suspended in n-heptane (99 g in total); a spatula was used to break up large chunks of solid. The solid was collected by filtration through a 10 micron polyethylene frit in a disposable filter funnel and washed with n-heptane (18 g). Following drying on the frit, the solid was transferred into a flask to be dried under high vacuum (1 Torr, room temperature). A white solid was produced (6.11 g, 0.028 mol, 89.2% isolated yield). NMe2EtNHtBu×2 HCl can also be synthesized in methanol as the solvent, in which no solid precipitation during the HCl bubbling was observed. Elemental analysis confirmed its assignment to be the bis HCl salt.

| Sample | C [%] | H [%] | N [%] | CI [%] |
|---|---|---|---|---|
| NMe2EtNHtBu × | 44.24 | 10.21 | 12.90 | 32.65 |
| 2 HCl calculated | | | | |
| synthesis in | 44.07 | 10.39 | 12.82 | 32.40 |
| isopropanol | | | | |
| synthesis in | 44.04 | 10.29 | 12.79 | 32.51 |
| methanol | | | | |

### NMe2EtNHtBu×1 HCl, Ligand Mono HCl Salt, Synthesis

Ligand NMe2EtNHtBu×2 HCl (4.78 g, 0.022 mol) was dissolved in methanol (37.6 g). A solution of free ligand NMe2EtNHtBu (3.16 g, 0.022 mol) in methanol (14.5 g) was added to the stirring solution at room temperature. The sides of the flask were washed with methanol (2.6 g) to wash any material there back into the solution. The flask was closed with a rubber septum and its content was stirred overnight at room temperature. The reaction was concentrated by rotary evaporation, where initially a near colorless oil formed, which soon crystallized to form an off-white solid. It was dried for 3 h on the rotavap at 10 Torr, 45° C. This material (7.86 g, 99.0% isolated yield) was used in the Al complex synthesis.

### [NMe2EtNtBu]AlH2 Complex Synthesis from LiAlH4 and NMe2EtNHtBu×1 HCl

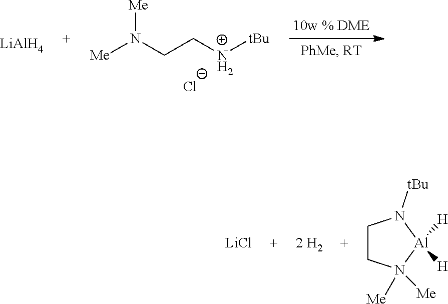

The ligand mono HCl salt, NMe2EtNHtBu×1 HCl, (2.60 g, 0.014 mol) was suspended in PhMe (81 g). One pellet of LiAlH4 (0.54 g, 0.014 mol) was added. After 2 h of stirring at room temperature no visible reaction had occurred. DME (8.6 g) was now added, whereupon visible bubble formation, both from the LiAlH4 pellet and from all within the liquid phase, started occurring. A colorless solution containing a suspended fine white powder (LiCl) was present after stirring for 16 h at room temperature. ¹H and ¹³C NMR analysis of the crude reaction mixture, using a sufficiently large number of scans, showed clean [NMe2EtNtBu]AlH2 product being present.

### Example 4: Synthesis of N-(t-butyl) (N′,N′-pyrrolidino) ethanediamine dihydridoalane (Compound 2)

Process B—[PyrNEtNtBu]AlH2 Complex Synthesis—One Pot from Free Ligand, NEt3, AlCl3 and LiAlH4 in PhMe—Oxygen-Free Solvent Route

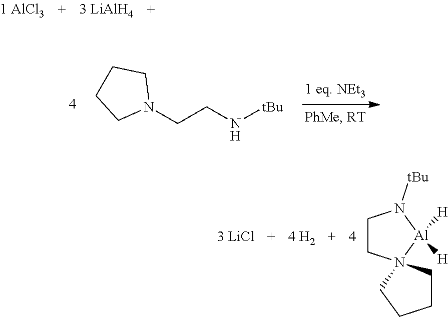

### Synthesis

Into a plastic bottle LiAlH4 (15.33 g, 0.404 mol) pellets (˜0.5 g each) were weighed out, and the bottle was closed until used. PyrNEtNHtBu ligand (87.13 g, 0.512 mol, 0.95 eq., limiting reagent) was weighed out in a flask. AlCl3 (17.95 g, 0.135 mol) was weighed out in a beaker. Using PhMe (60 g) the AlCl3 was transferred via a funnel into a 1 L side-arm flask containing a magnetic stir bar. NEt3 (54.5 g, 0.539 mol) was added to a 250 ml flask containing a magnetic stir bar. PhMe (60 g) was added to the NEt3, and the combined liquid was stirred until a single phase was present. A temperature probe was now installed in the AlCl3 in PhMe suspension. Over the course of 20 min the NEt3/PhMe solution was added pipettewise to the AlCl3/PhMe suspension at a rate so that the internal temperature did not exceed 53° C. A clear, weakly orange solution formed. Once the internal temperature had cooled to 31° C., the temperature probe was replaced by a funnel. All ligand was now poured in, followed by washing of the ligand flask and funnel with PhMe (30 g). The temperature probe was installed again. A two liquid phases system, with a near identical temperature of 32° C., has formed, consisting of an upper colorless large and a lower orange small phase. The temperature probe was removed and washed with PhMe (3 g). In total, 153 g of PhMe were used in this reaction. A solid addition funnel was now installed, and the LiAlH4 pellets were added in 3 batches in 10 min intervals. The flask was now closed with a rubber septum and kept at room temperature, while keeping the side arm open, so that the produced H2 can escape into the box atmosphere. The glove box atmosphere was occasionally purged so as to remove the H2 from its atmosphere. After 7 days of reaction time, a fine white powder (LiCl) was present in a weakly yellow solution, indicating that the reaction had completed.

### Isolation

All PhMe and NEt3 was now evaporated using a Dewar style vacuum solvent trap condenser placed outside of the glove box under a fume hood, connected via tubing to the inside of the glove box. The 1 L reaction flask was slightly heated in an Al chip bath (Tset=30° C.) to facilitate evaporation. The resulting residue was taken up in n-heptane (150 g) and filtered to remove the LiCl through a 0.5 micron disk, cut out from a sock filter, placed on a 20 micron polyethylene frit in a disposable filter funnel, into a weighed 1 L side-arm containing a magnetic stir bar. The reaction flask and filter cake were washed with n-heptane (78 g). The heptane was now evaporated to obtain a near colorless liquid residue (102.9 g). A sample of it (0.6 g) was removed for NMR analysis.

### Purification

Distillation using our custom distillation head, FIG. 1, which allows the distillation of compounds under high vacuum whose melting point is above ambient temperature, provided 97.4 g (0.491 mol, 96.0% isolated yield) of purified product [PyrNEtNtBu]AlH2 as a colorless liquid. This [PyrNEtNtBu]AlH2 colorless liquid distillate has not crystallized for 4 months, as of the time of writing. 1H NMR (400 MHz, C6D6)=4.01 (bs, 2H), 3.09 (m, 2H), 2.76 (t, 2H), 2.60 (t, 2H), 2.02 (m, 2H), 1.69 (m, 2H), 1.52 (m, 2H), 1.14 (s, 9H). 13C NMR (100 MHz, C6D6)=59.53, 54.85, 51.16, 42.81, 30.52, 23.44. 27Al NMR (104 MHz, C6D6)=138 (bs). We analyzed 3 samples of [PyrNEtNtBu]AlH2 by NMR: crude, distillate, and after thermal treatment (115 h at 65° C. in a stainless steel vessel); each one at a different concentration. Each one of these 3 samples only showed a single ²⁷Al NMR peak at 138 ppm and all 3 samples had the same 1H NMR and ¹³C NMR chemical shifts.

### Example 5: Characterization of N-(t-butyl) (N′,N′-dimethyl) ethanediamine dihydridoalane LAlH₂ (1)

N-(t-butyl) (N′,N′-dimethyl) ethanediamine dihydridoalane was prepared as described above, resulting in a composition with a purity greater than 99%. It was found that compound 1 could be evaporated at elevated temperatures without decomposition, in contrast to conventional compositions. Additionally, when the composition was undercooled to ambient temperature, the liquid composition did not solidify over the course of weeks. In contrast, conventional compositions, even those reported as “analytically pure” with a purity between 97% and 99% were found to solidify instantly upon cooling.

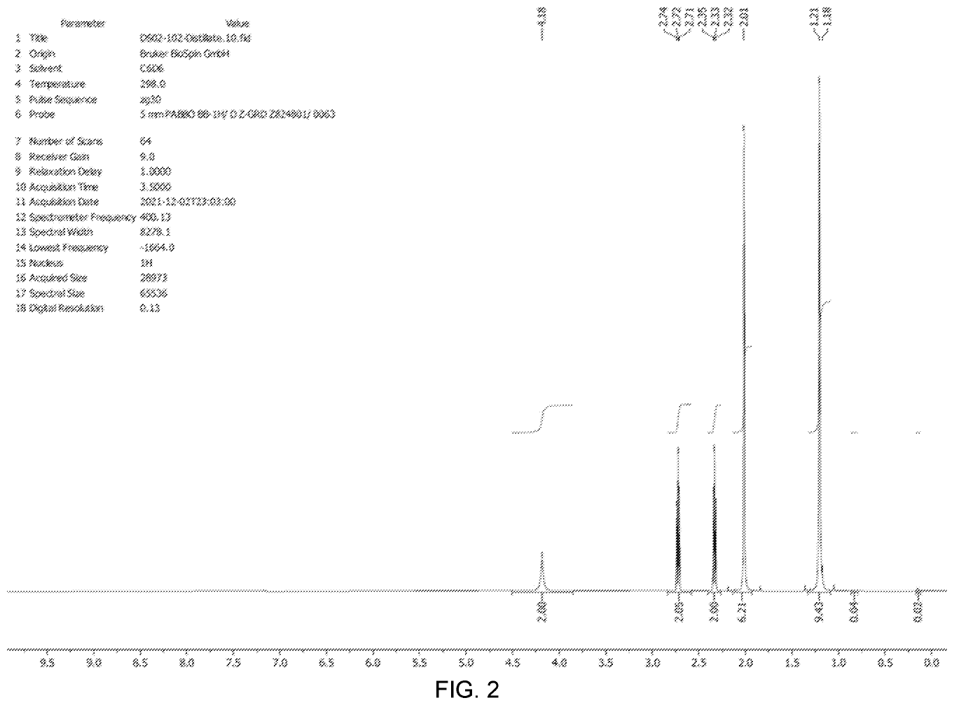

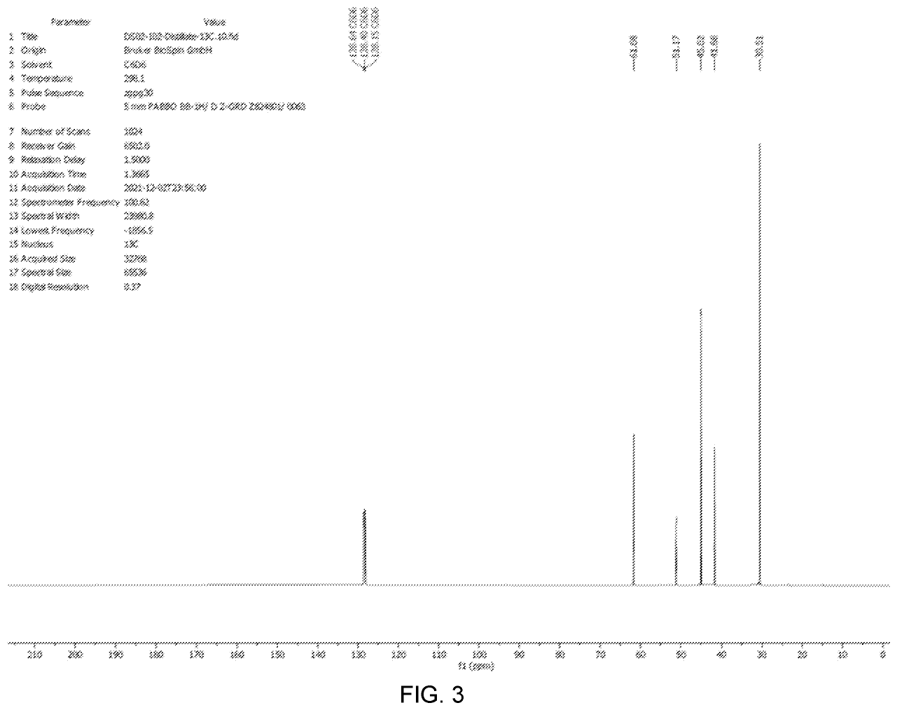

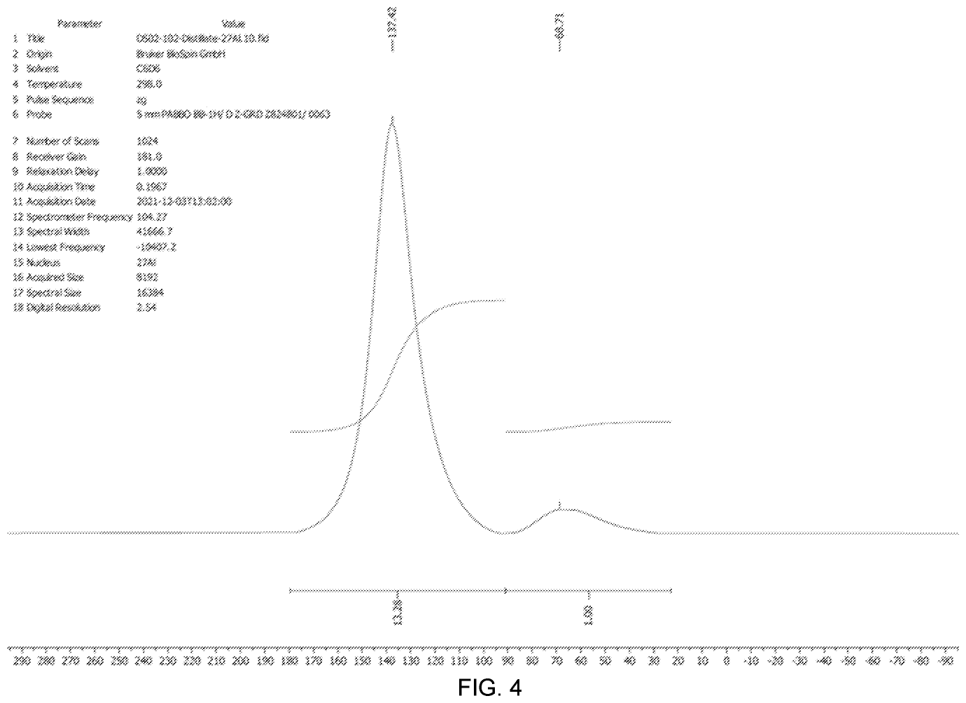

According to ²⁷Al studies in C6D6 solvent, compound 1 was found to exist in equilibrium between its monomeric and dimeric states in a concentration dependent manner. In the ²⁷Al NMR, FIG. 4, two peaks were observed: the one at 137 ppm is assigned to be the monomer, (Atwood et al. 1994) while the one at 69 ppm is assigned to be dimer. (McMahon et al. 1999) This assignment aligns with their concentration dependent ratio. The exact ¹H NMR chemical shift values, FIG. 2, of all but the CH2-NH protons (2.72 ppm) of [NMe2EtNtBu]AlH2 are highly dependent on the monomer/dimer ratio, but not any of the ¹³C NMR chemical shifts, FIG. 3. The values reported in the literature (Blakeney and Winter 2018) are those of a highly concentrated, thus mostly dimeric, sample. Without wishing to be bound by theory, it is believed that the monomeric and dimeric species take the forms:

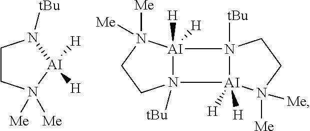

respectively.

### Example 6: Characterization of N-(t-butyl) (N′,N′-pyrrolidino) ethanediamine dihydridoalane (2)

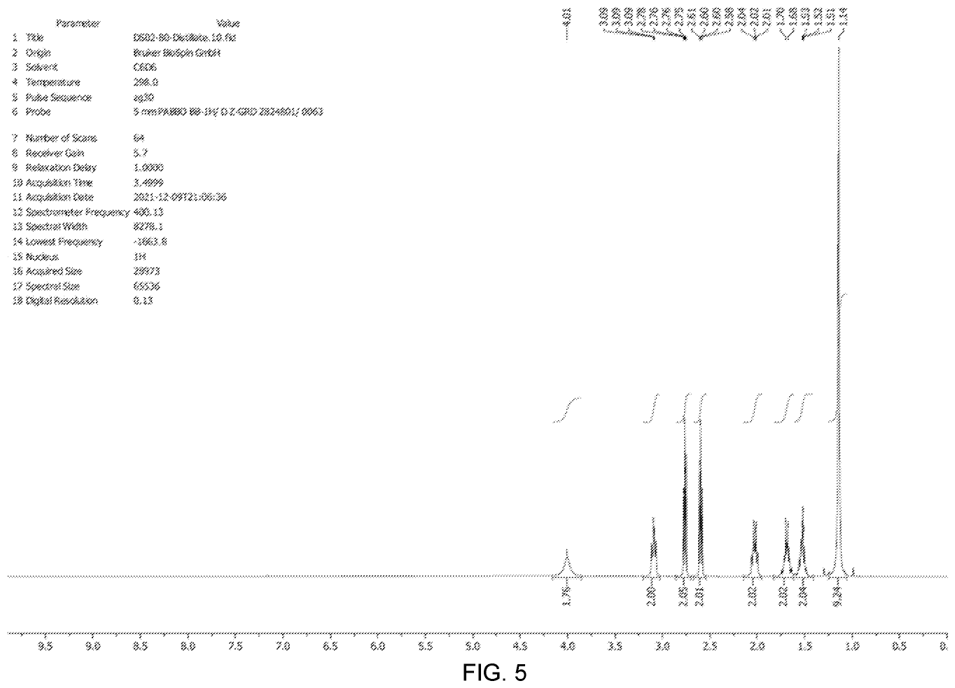

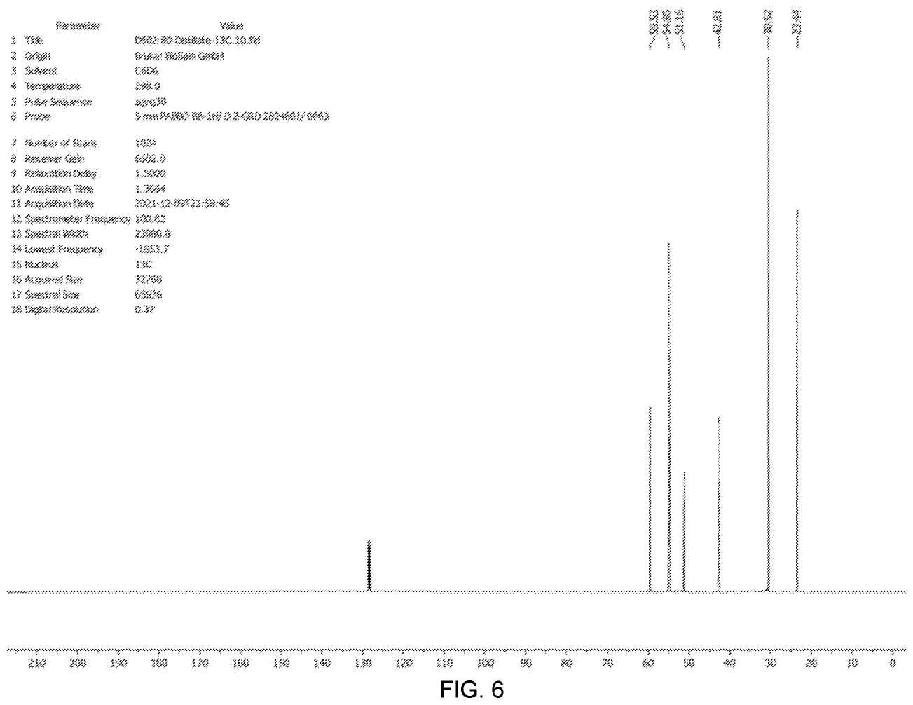

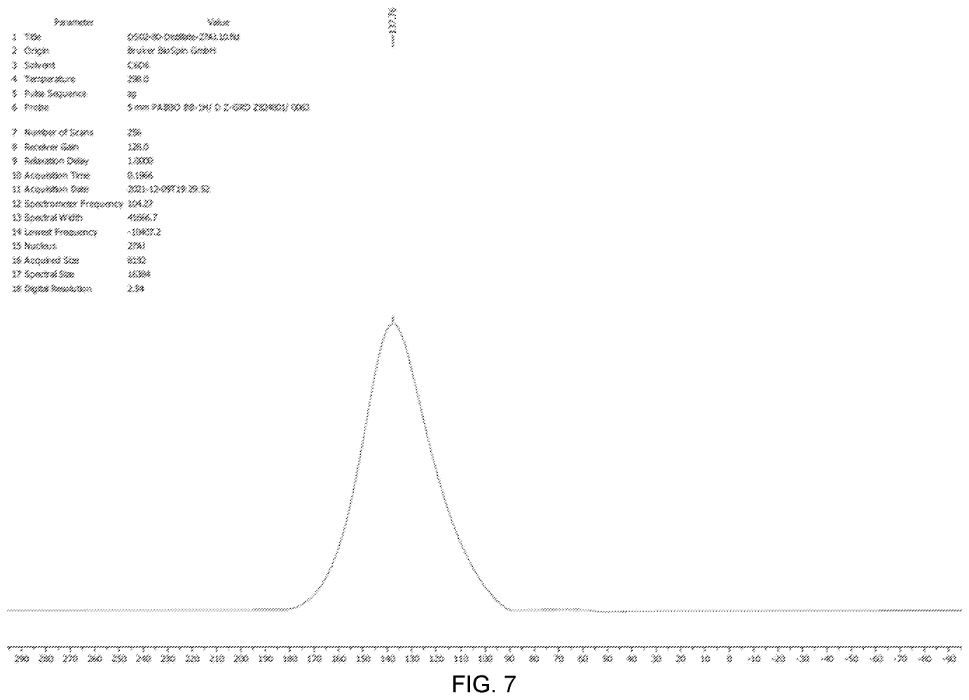

N-(t-butyl) (N′,N′-pyrrolidino) ethanediamine dihydridoalane was prepared as described above. The compound exhibited only a monomer peak as measured by ¹H, ¹³C, and ²⁷Al NMR (FIGS. 5-7). After heat treatment, there was still no evidence of a dimer or other multimeric species, indicating excellent thermal stability of the monomer. In the 3 analyzed samples of [PyrNEtNtBu]AlH2, each one at a different concentration, only a single chemical species was present. Each one of these 3 samples only showed a single ²⁷Al NMR peak at 138 ppm and all 3 samples had the same ¹H NMR and ¹³C NMR chemical shifts. Based on [PyrNEtNtBu]AlH2 being more sterically hindered than [NMe2EtNtBu]AlH2 and the single observed ²⁷Al NMR peak being at 138 ppm we assign a monomeric structure to compound [PyrNEtNtBu]AlH2. Compound [PyrNEtNtBu]AlH2 only being present in the monomer form may mean that compound [PyrNEtNtBu]AlH2 is a better “precursor” for CVD/ALD work, because it does not form the less volatile dimer.

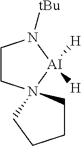

### Structure of [PyrNEtNtBu]AlH2

### Example 7: Purification and Monomerization of Ligand-Al-Hydride Complexes

Processes A, B, and C already provide very clean crude product. However, in order to have nano-clean material suitable as a CVD/ALD “precursor” chemical for electronics applications, we decided to further purify the crude [NMe2EtNtBu]AlH2 product by distillation. [NMe2EtNtBu]AlH2 has a reported melting point of 32° C. (Blakeney and Winter 2018; Blakeney et al. 2018) Surprisingly, we found that a special reactive distillation apparatus can be used to ‘monomerize’ dimeric ligand-Al-hydride complexes.

We thus used a standard 24/40 vacuum-jacketed distillation head, whose condenser water was set to 40° C., to distill 11.9 g of crude [NMe2EtNtBu]AlH2. This distillation resulted in ⅓ (3.8 g) of the initial material collected as a crystalline white solid in the receiving flask. We measured its bp=56° C. at 0.7 Torr. However, a second ⅓ of crystalline white solid clogged up the condenser tube below the circulating fluid regions, while the remaining ⅓ of material remained in the sump. In order to be able to purify larger quantities of [NMe2EtNtBu]AlH2 by distillation, we designed a custom manufactured distillation head (FIG. 1). More generally, our custom distillation head is suitable to distill at the laboratory scale compounds under high vacuum whose melting point is above ambient temperature. The raising tube of our custom distillation head is vacuum jacketed, while all of its condenser tube, including the complete ground-glass joint to the receiving flask, is enclosed by circulating fluid, whose temperature can be set so that the product remains above its melting point. Using this distillation head, we were able to obtain 18.1 g of [NMe2EtNtBu]AlH2 as a crystalline white solid (FIG. 1), without the condenser tube clogging up, from the distillation of about 23 g of crude material. This distillation apparatus thus allowed the advantageously purification of multi-gram quantities of the compound of interest.

### Comparative Example 1—[NMe2EtNtBu]AlH2 Complex Synthesis—One Pot from Free Ligand, AlCl3 and LiAlH4 in Monoglyme

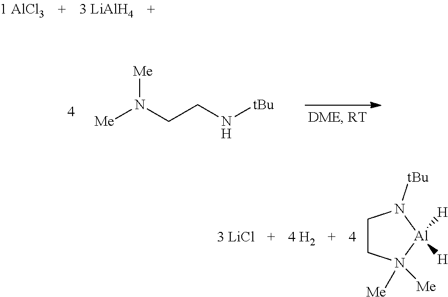

### Synthesis

Into a plastic bottle LiAlH4 (22.4 g, 0.590 mol) pellets (˜0.5 g each) were weighed out, and the bottle was closed until used. NMe2EtNHtBu ligand (107.84 g, 0.748 mol, 0.95 eq., limiting reagent) was weighed out in a flask. AlCl3 (26.23 g, 0.197 mol) was weighed out in a beaker. Using dimethoxyethane (DME, monoglyme, 133 g) the AlCl3 was transferred via a funnel into a 1 L side-arm flask containing a magnetic stir bar. A temperature probe was installed. A weakly yellow suspension of mostly undissolved AlCl3 formed having a temperature of 46° C. The temperature probe was removed and washed with DME (10 g). Over the course of 20 min the ligand was added pipettewise to the AlCl3/DME suspension, whereupon all AlCl3 dissolved to form a weakly yellow solution. The ligand flask was washed with DME (72 g). The temperature probe was installed again, now measuring 31° C. Over the course of 2.5 h the LiAlH4 pellets were slowly added, so that the internal temperature did not exceed 43° C. Upon the addition of LiAlH4 immediate formation of a large amount of gas (H2) occurs immediately. The temperature probe was removed and it and the sides of the flask washed with DME (61 g). In total, 276 g of DME were used in this reaction. The flask was now closed with a rubber septum and kept at room temperature, while keeping the side arm open, so that the produced H2 can escape into the box atmosphere. The glove box atmosphere was frequently purged so as to remove the H2 from its atmosphere. Just 15 h after the last LiAlH4 had been added the reaction had completed: a fine white powder (LiCl) was present in a very weakly yellow solution.

### Isolation

All DME was now evaporated using a Dewar style vacuum solvent trap condenser placed outside of the glove box under a fume hood, connected via tubing to the inside of the glove box. The 1 L reaction flask was slightly heated in an Al chip bath (Tset=30° C.) to facilitate evaporation. The resulting white crystalline residue was taken up in n-heptane (120 g) and filtered to remove the LiCl through a 0.5 micron disk, cut out from a bag filter, placed on a 20 micron polyethylene frit in a disposable filter funnel, into a weighed 1 L side-arm containing a magnetic stir bar. The reaction flask and filter cake were washed with n-heptane (80 g). The heptane was now evaporated to obtain a near colorless liquid residue (128.7 g), which 10 days later had become a white crystalline solid. A sample of it (0.3 g) was removed for NMR analysis.

### Purification

Distillation using our custom distillation head, FIG. 1, which allows the distillation of compounds under high vacuum whose melting point is above ambient temperature, provided 118.5 g (0.688 mol, 92.0% isolated yield) of purified product [NMe2EtNtBu]AlH2 (bp=56° C. at 0.7 Torr). The product of this DME route is spectroscopically and chemically identical to the product of the Oxygen-free solvent NEt3/PhMe route, although risks the incorporation of trace oxygen-containing species, such as trace DME.

A summary of the conventional synthesis approaches is provided in Table 1:

TABLE 1
Comparison of prior art typical approaches to current approach

| Reference | Process Steps/Reaction(s) | Solvent | Temp. | | Product | Yield |
|---|---|---|---|---|---|---|
| (Ruff and | (1) LiAlH₄ + NMe₃*HCl→ AlH₃*NMe₃ + | Et₂O | −177° C. | | AlH₃*NMe₃ | 88% |
| Hawthorne | LiCl + H₂ | | to 25° C. | | | |
| 1960) | | | | | | |
| (Frigo et | (1) Mix AlCl₃ + 3 LiAlH₄ in pentane = Soln K | Pentane | Reflux | | AlH₃*NEtMe₂ | 80% |
| al. 1994) | (2) NEtMe₂ + Soln K→ 3 LiCl + 4 AlH₃*NEtMe₂ | | ~35° C. | | | |
| (Beachley | (1) Method of Ruff and Hawthorne above | Et₂O | 25° | C. | N,N′,N′- | 95-99% |
| and Racette | (2) AlH₃*NMe₃ + HN(R)CH₂CH₂NR′₂ → | | | | substituted | H₂ basis |
| 1976) | Product + H₂ | | | | ethanediamine | |
| | | | | | dihydridoalane | |
| | | | | | (LAlH₂) | |
| (Atwood et | (1) Method of Ruff and Hawthorne above | Et₂O | −80° | C. | LAlH₂ | 60% |
| al. 1994) | (2) AlH₃*NMe₃ + HN(R)CH₂CH₂NRH | | | | | |
| | →Product + H₂ | | | | | |
| (McMahon et | (1) Method of Ruff and Hawthorne above | Et₂O, | −78° | C. | N,N′- | 60-80% |
| al. 1999) | (2) AlH₃*NMe₃ + HN(R)CH₂CH₂NR′H | hexane | | | substituted | |
| | →Product + H₂ | | | | ethanediamine—AlH₂ | |
| Choi | (1) Prepare and isolate | Pentane | −80° | C. | LAlH₂ | Not |
| 5880303 | R₂NCH₂CH₂NHR¹*HCl | | | | | reported |
| | (2) LiAlH₄ + R₂NCH₂CH₂NHR¹*HCl→ | | | | | |
| | Product + 2 H₂ | | | | | |
| (Blakeney et | (1) Prepare Soln A = LiAlH₄ + Et₂O, Soln B = | Et₂O | −30° | C. | LAlH₂ | 46-60% |
| al. 2018) | AlCl₃ + Et₂O | | | | | |
| | (2) Soln A + Soln B→ AlH₃*Et₂O (Soln C) | | | | | |
| | (chill) | | | | | |
| | (3) Prepare Soln D = HN(R)CH₂CH₂NR′₂ + Et₂O | | | | | |
| | (4) Soln D + Soln C→ Product + Et₂O + | | | | | |
| | LiCl + 4 H₂ | | | | | |
| (Dehmel et | (1) Method of Ruff and Hawthorne above | Et₂O | 0° | C. | LAlH₂ | |
| al. 2021) | (2) AlH₃*NMe₃ + HN(R)CH₂CH₂NRH | toluene | | | | |
| | →Product + H₂ | | | | | |
| Inventive | (1) Prepare Soln E = AlCl₃ + NEt₃ in toluene | toluene | 25° | C. | LAlH₂ | Isolated |
| Example A | (2) Prepare Soln F = HN(R)CH₂CH₂NR′₂ + | | | | | yield |
| | Soln E | | | | | |
| | (3) Soln F + 3 LiAlH₄ → 4 Product + 3 | | | | | 95.1% |
| | LiCl + H₂ (7 days at room temperature) | | | | | |
| Inventive | (4) Prepare Soln I = AlCl₃ + monoglyme | Monoglyme | 25° | C. | LAlH₂ | Isolated |
| Example B | (5) HN(R)CH₂CH₂NR′₂ + Soln I→ Soln J | | | | | yield |
| | (6) Soln H + 3 LiAlH₄ → 4 Product + | | | | | 92.0% |
| | 3 LiCl + H₂ (16 h) | | | | | |
| Comparative | (1) Purchase AlH₃*NEtMe₂ or method of | toluene | 25° | C. | LAlH₂ | Pure |
| Example A | Frigo above | | | | | product |
| | (2) AlH₃*NEtMe₂ + HN(R)CH₂CH₂NR′₂ | | | | | by NMR |
| | →Product + H₂ | | | | | |
| Comparative | (1) Synthesize L-H*2HCl; L = —N(R)CH₂CH₂NR′₂ | (1,2) | 25° | C. | LAlH₂ | Pure |
| Example B | (2) L-H*2HCl + L-H→ L-H*HCl | MeOH (3) | | | | product |
| | (3) LiAlH₄ + L-H*HCl→ LAlH₂ + 2 H₂ + LiCl | PhMe + 10% | | | | by NMR |
| | | monoglyme | | | | |
| Comparative | (1) Prepare Soln G = AlCl₃ + NEt₃ in heptane | heptane | 25° | C. | Unreacted | NA |
| Example C | (2) Prepare Soln H = HN(R)CH₂CH₂NR′₂ + Soln G | | | | LiAlH₄ present | |
| | (3) Soln H + 3 LiAlH₄ → 4 Product + 3 LiCl + H₂ | | | | after 14 days | |
| Comparative | (1) Prepare Soln E = AlCl₃ + NEtMe₂ in toluene | toluene | 25° | C. | Product not | NA |
| Example D | (2) Prepare Soln F = HN(R)CH₂CH₂NR′₂ + Soln E | | | | isolated | |

| | | | | | |
|---|---|---|---|---|---|
| | (3) Soln F + 3 LiAlH₄ → 4 Product + 3 LiCl + H₂ | | | (Reaction rate | |
| | | | | is less than | |
| | | | | half of Ex. 1) | |
| Comparative | (1) AlCl₃ + NEt₃ in toluene→ Soln E | toluene | 35° C., | Orange by- | Crude |
| Example E | (2) HN(R)CH₂CH₂NR′₂ + Soln E→ Soln F | | 45° C. | product | yield |
| | (3) Soln F + 3 LiAlH₄ → 4 Product + | | | produced | 95+% |
| | 3 LiCl + H₂ (7 days) | | | | |

Various exemplary embodiments of the disclosure include, but are not limited to the enumerated embodiments of the claims as listed below, which can be combined in any number and in any combination that is not technically or logically inconsistent.

The particulars shown herein are by way of example and for purposes of illustrative discussion of certain embodiments of the present disclosure only and are presented in the cause of providing what is believed to be the most useful and readily understood description of the principles and conceptual aspects of various embodiments of the disclosure. In this regard, no attempt is made to show details associated with the methods of the disclosure in more detail than is necessary for the fundamental understanding of the methods described herein, the description taken with the examples making apparent to those skilled in the art how the several forms of the methods of the disclosure may be embodied in practice. Thus, before the disclosed processes and devices are described, it is to be understood that the aspects described herein are not limited to specific embodiments, apparatus, or configurations, and as such can, of course, vary. It is also to be understood that the terminology used herein is for the purpose of describing particular aspects only and, unless specifically defined herein, is not intended to be limiting.

The terms “a,” “an,” “the” and similar referents used in the context of describing the methods of the disclosure (especially in the context of the following embodiments and claims) are to be construed to cover both the singular and the plural, unless otherwise indicated herein or clearly contradicted by context.

All methods described herein can be performed in any suitable order of steps unless otherwise indicated herein or otherwise clearly contradicted by context. The use of any and all examples, or exemplary language (e.g., “such as”) provided herein is intended merely to better illuminate the methods of the disclosure and does not pose a limitation on the scope of the disclosure. No language in the specification should be construed as indicating any non-claimed element essential to the practice of the methods of the disclosure.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

As will be understood by one of ordinary skill in the art, each embodiment disclosed herein can comprise, consist essentially of or consist of its particular stated element, step, ingredient or component. As used herein, the transition term “comprise” or “comprises” means includes, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the embodiment to the specified elements, steps, ingredients or components and to those that do not materially affect the embodiment.

All percentages, ratios and proportions herein are by weight, unless otherwise specified.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

Groupings of alternative elements or embodiments of the disclosure are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Some embodiments of various aspects of the disclosure are described herein, including the best mode known to the inventors for carrying out the methods described herein. Of course, variations on these described embodiments will become apparent to those of ordinary skill in the art upon reading the foregoing description. The skilled artisan will employ such variations as appropriate, and as such the methods of the disclosure can be practiced otherwise than specifically described herein. Accordingly, the scope of the disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

The phrase “at least a portion” as used herein is used to signify that, at least, a fractional amount is required, up to the entire possible amount.

In closing, it is to be understood that the various embodiments herein are illustrative of the methods of the disclosures. Other modifications that may be employed are within the scope of the disclosure. Thus, by way of example, but not of limitation, alternative configurations of the methods may be utilized in accordance with the teachings herein. Accordingly, the methods of the present disclosure are not limited to that precisely as shown and described.

### REFERENCES

1. Atwood, Jerry L., Stacey M. Lawrence, and Colin L. Raston. 1994. “N, N′-Di-Tert-Butylethylenediamine-ClnH3-nAlNMe3 Derivatives: Alane-Rich [(H2Al) 2 ${$μ-N (But) CH2$} 2] and Stable, Intramolecular Secondary Amine Alane Complexes [ClnH2-nAl {$N (H)(But) CH2CH2NBut], N=0, 1.” Journal of the Chemical Society. Chemical Communications, no. 1: 73-74.
2. Baker, Robert J., Cameron Jones, Peter C. Junk, and Marc Kloth. 2004. “Kinetic Control over the Thermal Stability of the In□H Bond: Synthesis and Characterization of Amido Indium Hydride Complexes.” Angewandte Chemie International Edition. https://doi.org/10.1002/anie.200460304.
3. Beachley, O. T., and K. C. Racette. 1976. “Chelation in Organoaluminum-Nitrogen Chemistry.” Inorganic Chemistry 15 (9): 2110-15.
4. Blakeney, Kyle J., Philip D. Martin, and Charles H. Winter. 2018. “Aluminum Dihydride Complexes and Their Unexpected Application in Atomic Layer Deposition of Titanium Carbonitride Films.” Dalton Transactions 47 (32): 10897-905.
5. Blakeney, Kyle J., and Charles H. Winter. 2018. “Atomic Layer Deposition of Aluminum Metal Films Using a Thermally Stable Aluminum Hydride Reducing Agent.” Chemistry of Materials: A Publication of the American Chemical Society 30 (6): 1844-48.
6. Choi, Hyungsoo. 1999. Amidoalane precursors for chemical vapor deposition of aluminum. USPTO 5880303. US Patent, filed Oct. 3, 1997, and issued Mar. 9, 1999. https://patentimages.storage.googleapis.com/e1/60/44/15291e38d472a4/US5880303.pdf.
7. Dehmel, Maximilian, Angelina Köhler, Helmar Görls, and Robert Kretschmer. 2021. “Synthesis, Characterization, and Reactivity of Group 13 Hydride Complexes Based on Amido-Amine Ligands.” Dalton Transactions 50 (24): 8434-45.
8. Elers, K-E, T. Blomberg, M. Peussa, B. Aitchison, S. Haukka, and S. Marcus. 2006. “Film Uniformity in Atomic Layer Deposition.” Chemical Vapor Deposition. https://doi.org/10.1002/cvde.200500024.
9. Frigo, D. M., G. J. M. van Eijden, P. J. Reuvers, and C. J. Smit. 1994. “Preparation and Properties of Alane Dimethylethylamine, a Liquid Precursor for MOCVD.” Chemistry of Materials: A Publication of the American Chemical Society 6 (2): 190-95.
10. Hicks, Jamie, Petra Vasko, Jose M. Goicoechea, and Simon Aldridge. 2021. “The Aluminyl Anion: A New Generation of Aluminium Nucleophile.” Angewandte Chemie 60 (4): 1702-13.
11. Kim, Hogyoung, Seok Choi, and Byung Joon Choi. 2020. “Forward Current Transport Properties of AlGaN/GaN Schottky Diodes Prepared by Atomic Layer Deposition.” Coatings World 10 (2): 194.
12. Marlett, Everett M., and Won Suh Park. 1990. “Dimethylethylamine Alane and N-Methylpyrrolidine Alane. A Convenient Synthesis of Alane, a Useful Selective Reducing Agent in Organic Synthesis.” The Journal of Organic Chemistry 55 (9): 2968-69.
13. McMahon, C. Niamh, Julie A. Francis, Simon G. Bott, and Andrew R. Barron. 1999. “Aluminium Compounds Containing Bidentate Ligands: Ligand Base Strength and Remote Geometric Control over Degree of Association.” Journal of the Chemical Society, Dalton Transactions 0 (1): 67-72.
14. Ruff, John K., and M. Frederick Hawthorne. 1960. “The Amine Complexes of Aluminum Hydride. I.” Journal of the American Chemical Society 82 (9): 2141-44.
15. Singh, Joseph A., Nuoya Yang, and Stacey F. Bent. 2017. “Nanoengineering Heterogeneous Catalysts by Atomic Layer Deposition.” Annual Review of Chemical and Biomolecular Engineering 8 (June): 41-62.
16. Tang, Shaokun, and Hua Zhao. 2014. “Glymes as Versatile Solvents for Chemical Reactions and Processes: From the Laboratory to Industry.” RSC Advances. https://doi.org/10.1039/c3ra47191h.

We claim:

1. A composition comprising a compound having the structural formula (I): 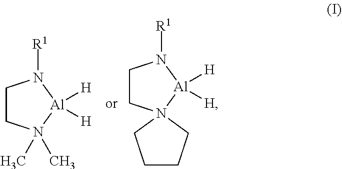
wherein R¹ is a unsubstituted butyl group, and wherein the composition has a purity greater than 99%.

2. The composition of claim 1, wherein R¹ is t-butyl or sec-butyl.

3. A composition comprising a compound having the structural formula: 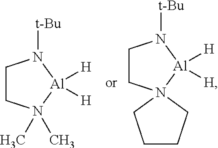
wherein the composition has a purity greater than 99%.

4. The composition of any of claims 1-3, wherein the compound is N-(t-butyl) (N′,N′-dimethyl) ethanediamine dihydridoalane.

5. The composition of any of claims 1-3, wherein the compound is N-(t-butyl) (N′,N′-pyrrolidino) ethanediamine dihydridoalane.

6. The composition of any of claims 1-5, wherein the composition comprises no more than 1000 ppm of an oxygen-containing species.

7. The composition of any of claims 1-5, wherein the composition comprises no more than 100 ppm of an oxygen-containing species.

8. The composition of any of claims 1-5, wherein the composition comprises no more than 10 ppm of an oxygen-containing species.

9. The composition of any of claims 6-8, wherein the oxygen-containing species comprises an ether or a glyme.

10. The composition of any of claims 4-7, wherein the oxygen-containing species comprises diethyl ether, monoglyme, diglyme, triglyme, or tetraglyme.

11. The composition of any of claims 1-3, and 6-10, wherein the compound is N-(t-butyl) (N′,N′-pyrrolidino) ethanediamine dihydridoalane, and the composition is a liquid composition at ambient pressure and temperature.

12. The composition of any of claims 1-3, and 6-11, wherein the composition comprises less than 5 wt % solids at a temperature of no more than 25° C.

13. The composition of any of claims 5-10, wherein the compound is N-(t-butyl) (N′,N′-pyrrolidino) ethanediamine dihydridoalane, and is present in at least 99 mol % monomeric form.

14. The composition of any of claims 5-10, wherein the compound is N-(t-butyl) (N′,N′-pyrrolidino) ethanediamine dihydridoalane, and is present in at least 99.9 mol % monomeric form.

15. A method of making a compound having the structural formula (II) 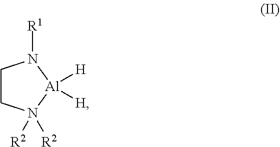
wherein R¹ is a C₁-C₃₃ hydrocarbon, and each R² are independently C₁-C₇ hydrocarbon, or both R² come together to form a substituted or unsubstituted pyrrolidinyl ring; the method comprising:
providing a first solution comprising aluminum trichloride, a chelating agent, and a solvent, wherein the solvent is an aromatic solvent or a chelating solvent;
to the first solution, adding a diamine ligand of formula HN(R¹)CH₂CH₂N(R²)₂ to form a second solution; and
to the second solution, adding a hydride-containing reducing agent to form the composition.

16. The method of claim 15, wherein R¹ is a C₁-C₈ alkyl group, or aryl group, wherein the aryl group comprises 1-5 phenyl rings, wherein the phenyl rings are fused or joined by C₁ bridging carbons, and wherein each phenyl ring is independently and optionally substituted by 1-3 C₁-C₄ alkyl groups.

17. The method of claim 15, wherein R¹ is an aryl group, and wherein the aryl group is 2,6-di-iso-propylphenyl, 2,6-bis(diphenyl-methyl)-p-tolyl, or 2,6-dimethylphenyl.

18. The method of claim 15, wherein R¹ is a C₂-C₆ alkyl group.

19. The method of claim 18, wherein R¹ is an unsubstituted butyl group.

20. The method of claim 18, wherein R¹ is t-butyl or sec-butyl.

21. The method of claim 18, wherein R¹ is t-butyl.

22. The method of any of claims 15-21, wherein each R² is independently an unsubstituted C₁-C₄ alkyl group.

23. The method of claim 22, wherein each R² is methyl.

24. The method of any of claims 15-21, wherein both R² come together to form a substituted or unsubstituted pyrrolidinyl ring.

25. The method of claim 24, wherein both R² come together to form an unsubstituted pyrrolidinyl ring.

26. The method of claim 15, wherein the compound is the compound of any of claims 1-14.

27. The method of any of claims 15-26, wherein the chelating agent is an amine.

28. The method of claim 27, wherein the chelating agent is of formula N(R³)₃, wherein each R³ is independently C₁-C₈ alkyl or aryl.

29. The method of any of claims 15-28, wherein the chelating agent is triethylamine.

30. The method of any of claims 15-29, wherein the solvent is an aromatic solvent.

31. The method of claim 30, wherein the aromatic solvent comprises benzene, toluene, xylene, ethylbenzene, or trimethylbenzene.

32. The method of any of claims 15-29, wherein the solvent is a chelating solvent.

33. The method of claim 32, wherein the solvent comprises an ether.

34. The method of claim 33, wherein the solvent comprises diethyl ether, di-n-propyl ether, t-butyl methyl ether, tetrahydrofuran, monoglyme, diglyme, triglyme, or tetraglyme.

35. The method of any of claims 15-34, wherein the hydride-containing reducing agent is diisobutylaluminum hydride, lithium aluminum hydride, or sodium aluminum hydride.

36. The method of claim 25, wherein the hydride-containing reducing agent is lithium aluminum hydride.

37. The method of any of claims 15-36, further comprising distilling the composition, wherein the distilling increases the monomer proportion of the composition.

38. A distillation apparatus, the distillation apparatus comprising a distillation flask connected to a vacuum-jacketed ascending arm, which is connected to a fluid-jacketed descending arm at a joint, wherein the joint is enclosed by a fluid-jacket, which is connected to a receiving flask.

39. The distillation apparatus of claim 38, wherein the joint is entirely enclosed by the fluid jacket.

40. A method of increasing the monomer proportion of a composition, the method comprising:
providing a distillation apparatus (e.g., the distillation apparatus of claim 39 or claim 40) comprising a distillation flask connected to a vacuum-jacketed ascending arm, the vacuum-jacketed ascending arm being connected to a fluid-jacketed descending arm at a joint, wherein the joint is enclosed by the fluid-jacket, and the fluid-jacketed descending arm being connected to a receiving flask;
charging the distillation flask with a first composition comprising a compound of structural formula (I): 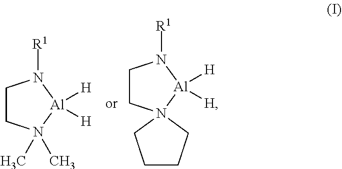
wherein R¹ is a unsubstituted butyl group, wherein the compound is present as a dimer, and optionally also present as a monomer;
reducing the pressure of the distillation apparatus to a pressure in the range of 0.1 Torr to 100 Torr, heating the fluid-jacketed descending arm to a temperature of at least the melting point of a second composition, and heating the distillation flask, whereby the second composition is distilled from the first composition and comprises an increased ratio of monomers to dimers compared to the first composition; and
collecting the second composition in the receiving flask.

41. The method of claim 40, wherein the distillation flask is heated to a temperature of at least 5° C. below the boiling point of the first composition, or greater.

42. The method of claim 41, wherein the distillation flash is heated to the boiling point of the first composition.
